(19) United States
(12) Patent Application Publication
(10) Pub. No.: US 2025/0149835 A1
(43) Pub. Date: May 8, 2025

(54) ELECTRICAL CONNECTOR WITH AN IMPROVED GROUNDING TERMINAL

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: FU-JIN PENG, Kunshan (CN); XI-MING YANG, Shenzhen (CN); YU-HUANG ZHAO, Shenzhen (CN)

(21) Appl. No.: 18/939,437

(22) Filed: Nov. 6, 2024

(30) Foreign Application Priority Data
Nov. 7, 2023 (CN) 202322990742.0

(51) Int. Cl. H01R 13/6597; H01R 13/24; H01R 13/422

(52) U.S. Cl. CPC H01R 13/6597; H01R 13/2435; H01R 13/422

(57) ABSTRACT

An electrical connector includes: an insulating housing having an upper surface, a lower surface, and elongate slots running through the housing; plural rows of first terminals retained in corresponding elongate slots, each of the first terminals comprising a body portion, a transverse portion, an upper elastic arm extending upwardly from the transverse portion and then bending above the body portion, a lower elastic arm extending downwardly from the transverse portion and then bending below the body portion, the transverse portions being connected with corresponding body portions of adjacent first terminals of each row; plural rows of second terminals secured to the housing, wherein a first notch is formed between the lower elastic arm and the body portion of an adjacent first terminal and opens downward, each of the elongate slots defines plural support platforms, and the first notches of each row of first terminals ride on corresponding support platforms.

### BACKGROUND OF THE INVENTION

### 1. Field of the Invention

The present invention relates to an electrical connector.

### 2. Description of Related Arts

U.S. Pat. No. 10,135,199 discloses an electrical connector having a grounding structure formed by a plurality of grounding terminals and a shielding sheet and a metal sheet overlapped with each other. The installation of the grounding structure is complicated, easy to affect the shielding effect due to improper overlap.

An improved electrical connector is desired.

### SUMMARY OF THE INVENTION

An object of the present invention is to provide an electrical connector with an improved grounding structure.

An electrical connector comprises: an insulating housing having an upper surface, a lower surface, and elongate slots running through the upper surface and the lower surface; plural rows of first terminals retained in corresponding elongate slots, each of the first terminals comprising a body portion, a transverse portion, an upper elastic arm extending upwardly from the transverse portion and then bending above the body portion, a lower elastic arm extending downwardly from the transverse portion and then bending below the body portion, the transverse portions of the first terminals being connected with corresponding body portions of adjacent first terminals of each row; and plural rows of second terminals secured to the insulating housing, wherein a first notch is formed between the lower elastic arm and the body portion of an adjacent first terminal and opens downward, each of the elongate slots defines plural support platforms, and the first notches of each row of first terminals ride on corresponding support platforms.

Other advantages and novel features of the invention will become more apparent from the following detailed description of the present embodiment when taken in conjunction with the accompanying drawings.

### BRIEF DESCRIPTION OF DRAWINGS

FIG. 1 is a front and top perspective view of an electrical connector of this present invention

FIG. 2 is a part of the electrical connector of FIG. 1;

FIG. 3 is a partially exploded view of the electrical connector in FIG. 2;

FIG. 4 is a perspective view of a first terminal of FIG. 3;

FIG. 5 is a perspective view of two adjacent first terminals connected with each other;

FIG. 6 is another perspective view of the first terminal in FIG. 4, wherein two elastic arms if the first terminal are depressed; and

FIG. 7 is an enlarged perspective view of a part of the electrical connector.

### DETAILED DESCRIPTION OF THE PREFERRED EMBODIMENT

Reference will now be made to the drawing figures to describe the preferred embodiment of the present invention in detail.

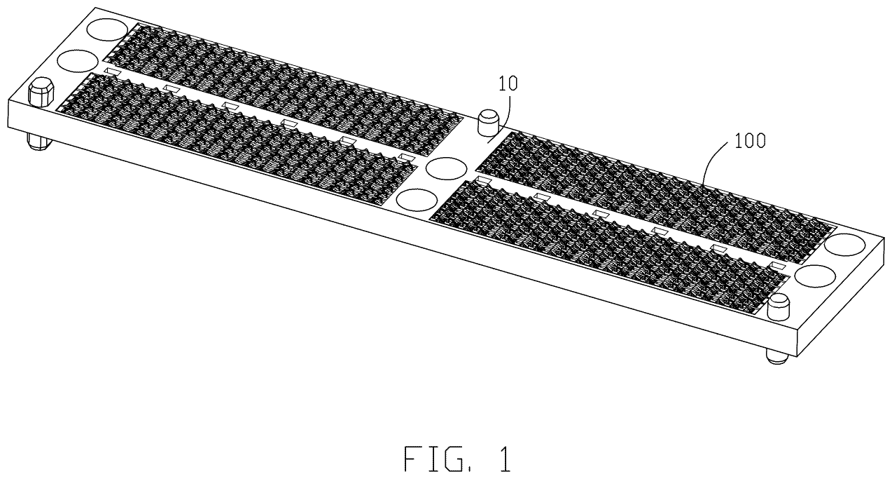

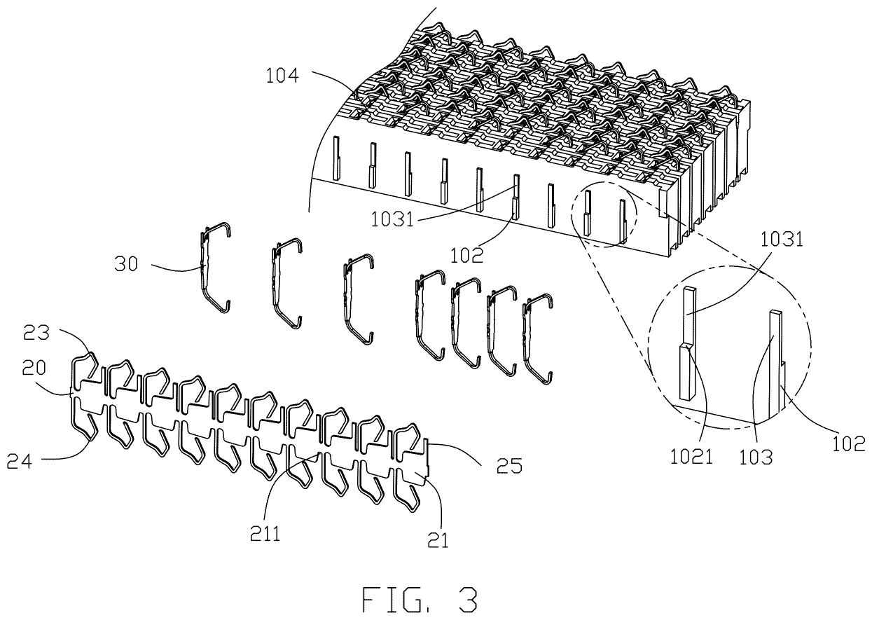

Referring to FIGS. 1-4, an electrical connector 100 of this present invention includes an insulating housing 10 and at least one row of first terminals 20. The insulating housing 10 has plural elongate slots 101 through an upper face and a lower face thereof and the row of first terminals 20 is retained in a corresponding elongate slot 101. The first terminal 20 includes a body portion 21 and a transverse portion 22 connecting the body portions 21 of adjacent first terminals 20, an upper elastic arm 23 extending upwardly from the transverse portion 22 and then bending and extending just above the body portion 21, and a lower elastic arm 24 extending downwardly from the transverse portion 22 and then bending and extending below the body portion 21. In this embodiment, the connector further includes plural second terminals 30 retained in passages 104 defined on the housing. The first terminals 20 are functioned as grounding terminals, and the second terminals 30 are functioned as signal terminals. The first terminals and the second terminals are arranged in rows and columns to form a matrix. In FIG. 1, the insulating housing 10 of this electrical connector has four terminal matrixes to connect with an IC chip and a circuit board.

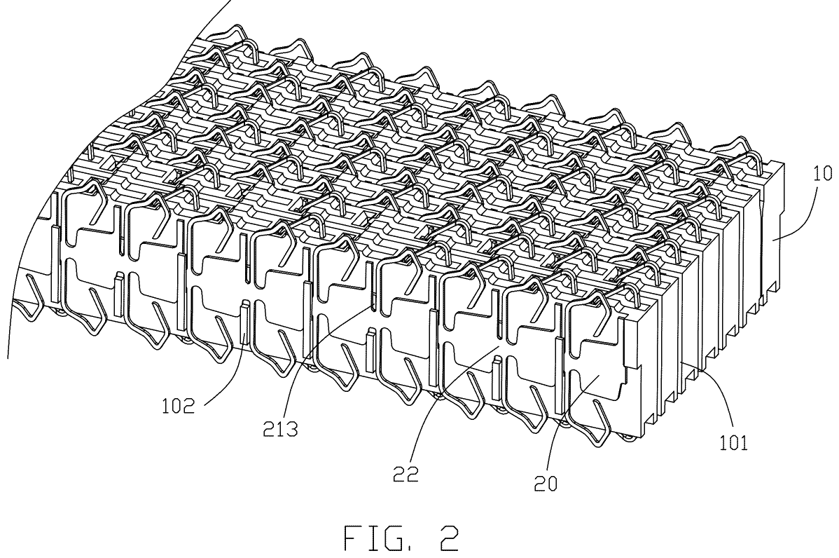

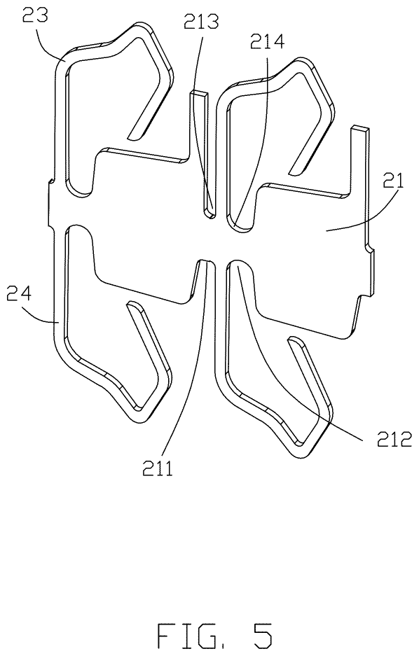

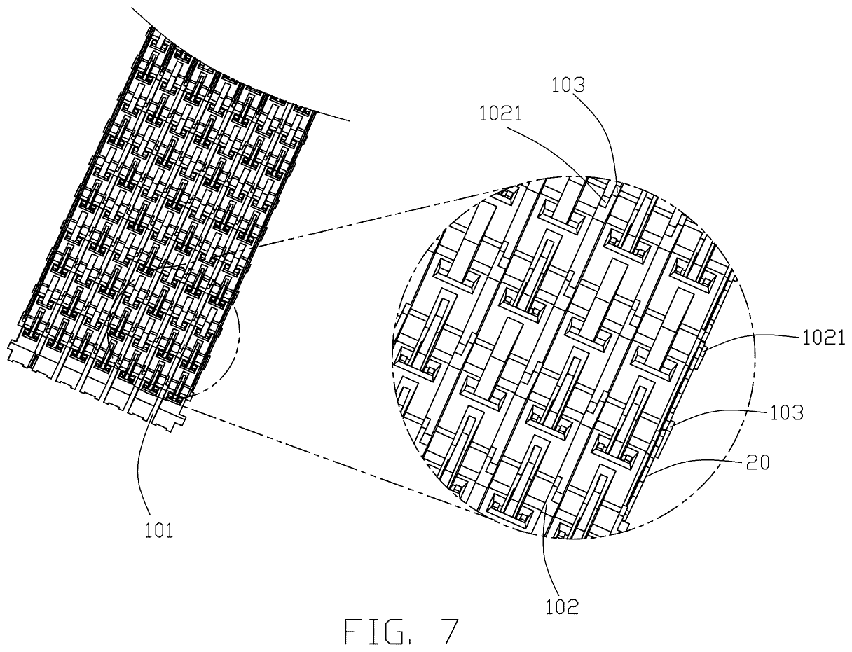

Referring to FIG. 2, in each terminal matrix, each row of the first terminals 20 or second terminals 30 is arranged in a transverse direction. The first terminals 20 of each row are united together and form an integral shield in the transverse direction. The second terminals of each row are separated from each other. The elongate slots 101 are located at opposite two sides of each row of the passages 104 so that two adjacent rows of the first terminal 20 are set at opposite sides of the row of the second terminals 30 along a front and back direction to form a shield for the second terminals 30. Combined with FIGS. 5 and 7, the integral shield has a plurality of first notch 211, each first notch 211 opens downwardly and the first notch 211 is located between the lower elastic arm 24 and the body portion 21 of an adjacent first terminal 20. The housing 10 has a plurality of support platforms 102 proximate to the lower surface in the elongate slot 101, each of the support platforms extending along the up and down direction. After the row of first terminals 20 are assembled downward into the housing 10, the first notches 211 ride on corresponding support platforms 102, so that the first terminals 20 are restricted in the assembling direction, thereby improving a retaining method of the terminals and reducing the size of the insulating housing 10.

Referring to FIGS. 2-3 and 7, the housing 10 has plural ribs 103 extending upwardly from corresponding support platforms 102 in the elongate slot 101. In this embodiment, the support platform 102 has a support surface 1021 at a part of the top thereof to support the first notch 211, and the rib 103 extends upwards from another part of the top of the support platform. The rib 103 extends along the inner face of the elongate slot 101 so that the support platform 102 and the rib 103 form a step structure. A side of the rib 103 exposing to the elongate slot 101 forms a contact surface 1031. The contact surface 1031 contact a surface of the transverse portion 22 in a thickness direction of the first terminal 20. The adjacent ribs 103 in the elongate slot 101 are located at opposite inner surfaces of the elongate slot 101 and orient in opposite directions to each other, thereby pressing against the transverse portions 22 in opposite direction to ensure the row of the first terminals 20 to be held flat in elongate slot 101.

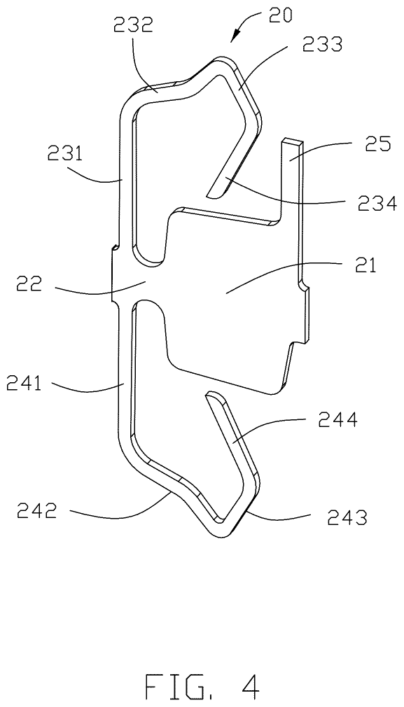

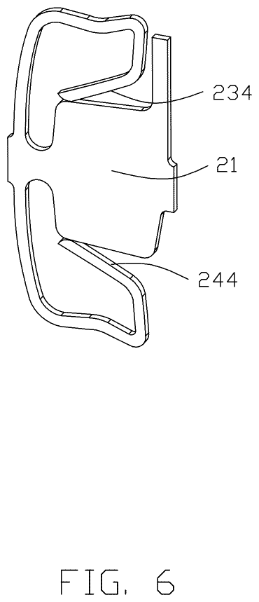

Referring to FIG. 4, the upper elastic arm 23 of the first terminal 20 includes an upward straight portion 231, an upward slanting portion 232, a downward slanting portion 233 and an inward slanting portion 234 in turn. The lower elastic arm 24 includes a downward straight portion 241, a downward slanting portion 242, an upward slanting portion 243 and an inward slanting portion 244 in turn. The upward straight portion 231 and the downward straight portion 241 extend in an upright direction from opposite sides of the transverse portion 22 respectively. The upward straight portion 231 extends beyond the top edge of the body portion 21, and the downward straight portion 241 extends beyond the bottom edge of the body portion 21. The body portion 21 connects one end of the transverse portion 22 in the transverse direction, and the inward slanting portion 234, 244 extend toward the body portion 21. The upper elastic arm 23 and the lower elastic arm 24 are disposed at opposite sides of the transverse portion 22. The body portion 21 is of an upright plate. The upper elastic arm 23, the lower elastic arm 24 and the transverse portion 22 are located in a same plane to facilitate the manufacturing method and improve a shielding effect. Referring to FIG. 6, the first terminal 20 is depressed and the inward slanting portion 234, 244 resist against the top and bottom edges of the body portion 21, respectively.

Referring to FIG. 2 and FIGS. 4-5, a third notch 213 opening upward is formed between the upper elastic arm 23 and the adjacent body portion 21, a fourth notch 214 opening upward is formed between the upper elastic arm 23 and the body portion 21, and a second notch 212 opening downward is formed between the lower elastic arm 24 and the body portion 21. In the transverse direction, the width of the first notch 211 is less than the width of the second notch 212, and the width of the third notch 213 is less than the width of the fourth notch 214, so that less space is remained between adjacent first terminals 20, the row of the first terminals is more compact to improve the shielding effect. In this embodiment, the first terminal 20 has a stopping portion 25 extending upwardly from the edge of the body portion 21 and proximate to the third notch 213. Therefore, the row of the first terminals 20 remain co-planar during insertion into the elongate slot 101 to enhance the shielding effect.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
an insulating housing having an upper surface, a lower surface, and elongate slots running through the upper surface and the lower surface;
plural rows of first terminals retained in corresponding elongate slots, each of the first terminals comprising a body portion, a transverse portion, an upper elastic arm extending upwardly from the transverse portion and then bending above the body portion, a lower elastic arm extending downwardly from the transverse portion and then bending below the body portion, the transverse portions of the first terminals being connected with corresponding body portions of adjacent first terminals of each row; and
plural rows of second terminals secured to the insulating housing;
wherein a first notch is formed between the lower elastic arm and the body portion of an adjacent first terminal and opens downward, each of the elongate slots defines plural support platforms, and the first notches of each row of first terminals ride on corresponding support platforms.

2. The electrical connector as claimed in claim 1, wherein the insulating housing has a plurality of ribs extending upwardly from corresponding support platforms in each elongate slot to press against opposite surfaces of the first terminal.

3. The electrical connector as claimed in claim 2, wherein each row of the first terminals is located in a plane.

4. The electrical connector as claimed in claim 3, wherein a second notch is formed between the lower elastic arm and the body portion of the first terminal and opens downwards, a third notch is formed between the upper elastic arm and the body portion of the adjacent first terminal and opens upwards, and a fourth notch is formed between the upper elastic arm and the body portion of the first terminal and opens upwards.

5. The electrical connector as claimed in claim 4, wherein the first terminal has a stopping portion extending upwardly from an upper edge of the body portion and located proximate to the third notch.

6. The electrical connector as claimed in claim 1, wherein the first terminals are used for grounding, and the second terminals are separated from each other and used for signal transmission.

7. An electrical connector comprising:
an insulating housing having an upper surface, a lower surface, and a plurality of passages and at least one elongate slot running through the upper surface and the lower surface;
a plurality of signal terminals retained in corresponding passages; and
at least one integral shield retained in the at least one elongate slot and comprising a plurality of grounding terminals, each of the grounding terminals comprising a body portion, a transverse portion, an upper elastic arm extending upwardly from the transverse portion, and a lower elastic arm extending downward from the transverse portion, the transverse portions being connected with the body portions of adjacent grounding terminals so the plurality of the grounding terminals are united as one-piece;
wherein the insulating housing has plural support platforms in the at least one elongate slot, the body portions and the lower elastic arms of adjacent grounding terminals define first notches, and the first notches open downwardly and ride on corresponding support platforms.

8. The electrical connector as claimed in claim 7, wherein the lower elastic arms and the body portions of the grounding terminals defines second notches opening downward, the upper elastic arms and the body portions of adjacent first terminals define third notches opening upwards, the upper elastic arms and the body portions of the grounding terminals defines fourth notches opening upwards, a width of the first notch is less than a width of the second notch, and a width of the third notch is less than a width of the fourth notch.

9. The electrical connector as claimed in claim 7, wherein the upper elastic arms extend above corresponding body portions, and the lower elastic arms extend below corresponding body portions.

10. The electrical connector as claimed in claim 9, wherein the upper elastic arm comprises an upward straight portion, an upward slanting portion, a downward slanting portion, and an inward slanting portion, and the lower elastic arm comprises a downward straight portion, a downward slanting portion, an upward slanting portion, and an inward slanting portion.

11. The electrical connector as claimed in claim 10, wherein the upward straight portion extends beyond a top edge of the body portion, and the downward straight portion extends beyond a bottom edge of the body portion.

12. The electrical connector as claimed in claim 10, wherein the inward slanting portions of the upper elastic arms and the lower elastic arms resist on the top edges and the bottom edges of the body portions, respectively, after being pressed.
